(19) United States
(12) Patent Application Publication
(10) Pub. No.: US 2015/0186615 A1
(43) Pub. Date: Jul. 2, 2015

(54) MEDICATION COMPLIANCE

(71) Applicant: REMIND TECHNOLOGIES INC., Humble, TX (US)

(72) Inventors: David Armor, Minneapolis, MN (US); Ashish Singal, Blaine, MN (US); Nicole Eugenia Pardo Lamos, Humble, TX (US); Thomas E. Nevins, St. Paul, MN (US); Arthur J. Matas, Minnetonka, MN (US); Saurav Paul, Minneapolis, MN (US); Christopher Martin, New Brighton, MN (US)

(21) Appl. No.: 14/415,070

(22) PCT Filed: Jul. 19, 2013
(86) PCT No.: PCT/US2013/051362

§ 371 Date: Jan. 15, 2015

Related U.S. Application Data
(60) Provisional application No. 61/741,471, filed on Jul. 19, 2012.

(51) Int. Cl. G06F 19/00

(52) U.S. Cl. CPC G06F 19/3462

(57) ABSTRACT

Systems and methods for improving or incentivizing patient compliance with a medical schedule are disclosed. A system can include a medication module and a sensing system. The medication module can be communicatively coupleable to a portable device and can include at least one compartment for storing and dispensing one or more doses of a medication in accordance with a medication program. The sensing mechanism can be associated with the medication module and can be configured to detect a medication dispensing activity from the compartment. The system can further include a portable device including an electronic communication module, which is configured to receive and provide to a user and at least one third party dosage or compliance information about the medication program, and a user-interface, which is configured to display the dosage or compliance information about the medication program to the user and receive data input from the user.

### CLAIM OF PRIORITY

This patent matter claims the benefit of priority of U.S. Provisional Patent Application Ser. No. 61/741,471, titled “MEDICATION COMPLIANCE” and filed on Jul. 19, 2012, which is hereby incorporated by reference in its entirety.

### BACKGROUND

Patients often fail to adhere to their personalized medication schedules. The complexity of a medication schedule and a daily routine of a patient are typically not readily compatible. Furthermore, patients become complacent over time and are not psychologically incentivized to continue adhering to medication schedules. Relying on patient memory for compliance with the medication schedule is not consistently reliable.

Recovery from many diseases is sensitive to the outcomes of medication compliance; these diseases can include solid organ transplantation, HIV, epilepsy, hypertension, congestive heart failure, cancer, and pediatric illness, among others. Failure to comply with a medication schedule when treating the diseases has been found to predict mobility and mortality. Non-compliance to a medication schedule can also increase the likelihood of patient disease complications, adverse reactions to medications, inappropriate dose escalation, treatment resistance, and poor recovery outcomes.

Medical health care expenditures associated with treating complications associated with non-compliance can include emergency care visits, prolonged hospitalizations, and long-term treatment. Non-compliance to a medication program can also affect the results and interpretations of clinical trials and, therefore, can lead to underestimated incidence of side effects, misinterpretation of pharmaco-economic analysis, or overestimated dosing requirements for marketed pharmaceuticals.

### Overview

A variety of factors affect patient compliance with a medication schedule. These factors can be associated with the patient, a therapy protocol, or social considerations. For example, the factors can include a patient's lifestyle or memory, number of doses, ethnicity, stage of disease, or physiological, social or economic factors. Non-adherence has been found to affect patients of all ages, both genders, and is equally as likely to involve higher-income, well-educated people as those at lower socioeconomic levels.

The present inventors have recognized, among other things, patient compliance with a medication schedule is an existing problem for the health care market. The present systems and methods can help provide a solution to this problem by combining the processing capabilities of a portable electronic device and a medication module for dispensing one or more doses of a medication.

The systems and methods disclosed in this patent document can be used to improve or incentivize patient compliance with a medical schedule. A system can include a medication module and a sensing system. The medication module can be communicatively coupleable to a portable device and can include at least one compartment for storing and dispensing one or more doses of a medication in accordance with a medication program. The sensing mechanism can be associated with the medication module and can be configured to detect a medication dispensing activity from the compartment. The system can further include a portable device including an electronic communication module, which is configured to receive and provide to a user and at least one third party dosage or compliance information about the medication program, and a user-interface, which is configured to display the dosage or compliance information about the medication program to the user and receive data input from the user.

To further illustrate the medical compliance systems and methods disclosed herein, a non-limiting list of examples is provided here:

In Example 1, a system can comprise a medication module and a sensing mechanism. The medication module can be communicatively coupleable to a portable device and can include at least one compartment for storing and dispensing one or more doses of a medication in accordance with a medication program. A communication module can be connected to the medication module. The sensing mechanism can be associated with the medication module and can be configured to detect a medication dispensing activity from the at least one compartment.

In Example 2, the system of Example 1 can optionally be configured to further comprise dosage or compliance information about the medication program, wherein the dosage or compliance information includes one or more of an alert, a positive reinforcement message or action, or a negative reinforcement message or action.

In Example 3, the system of any one or any combination of Examples 1 or 2 can optionally be configured such that the sensing mechanism includes a latch configured to control access to the at least one compartment.

In Example 4, the system of any one or any combination of Examples 1-3 can optionally be configured such that the communicative coupling between the medication module and the portable device includes one or more wires.

In Example 5, the system of any one or any combination of Examples 1-3 can optionally be configured such that the communicative coupling between the medication module and the portable device includes a wireless connection.

In Example 6, the system of any one or any combination of Examples 1-5 can optionally further comprise a portable device including an electronic communication module, which is configured to receive and provide to a user and at least one third party dosage or compliance information about the medication program, and a user-interface, which is configured to display the dosage or compliance information about the medication program to the user and receive data input from the user.

In Example 7, the system of Example 6 can optionally be configured such that the user-interface includes a display screen and a plurality of alphanumeric keys.

In Example 8, the system of any one or any combination of Examples 6 or 7 can optionally be configured such that the medication module is coupled to a housing of the portable device on a surface opposite the user-interface.

In Example 9, the system of any one or any combination of Examples 6 or 7 can optionally be configured such that the medication module forms a perimeter around one or more housing edges of the portable device and is coupled to the portable device at the one or more housing edges.

In Example 10, the system of any one or any combination of Examples 6-9 can optionally be configured such that the portable device includes a cellular telephone or a smart telephone.

In Example 11, the system of any one or any combination of Examples 1-10 can optionally be configured such that the medication module includes a drawer in which the at least one compartment is located.

In Example 12, the system of any one or any combination of Examples 1-11 can optionally further comprise a radio frequency identification (RFID) tag to be worn by a user, a mobile device, and a transceiver. The mobile device can be connected to the medication module. The transceiver can be located in the medication module and can be configured to receive a signal providing user location information from the RFID tag. The mobile device can be configured to transport the medication module to the user upon receiving instructions concerning the medication program and the location of the user.

In Example 13, the system of any one or any combination of Examples 1-12 can optionally be configured such that the at least one compartment is configured to receive a cartridge including a dosage of medication.

In Example 14, the system of Example 13 can optionally be configured such that the at least one compartment is configured to receive a plurality of cartridges. Each cartridge can include a dosage of medication.

In Example 15, a method of medication dosing can comprise receiving, at a portable device, a medication program including a medication dosage and medication timing for a user; storing at least one dosage of medication in a medication module coupleable to the portable device; alerting the user about the medication dosage at the medication timing; detecting a medication dispensing activity from the medication module; and informing one or both of the user or a third party about the user's compliance with the medication program.

In Example 16, the method of Example 15 can optionally be configured such that informing the user about compliance with the medication program includes sending the user a positive reinforcement message or action.

In Example 17, the method of Example 16 can optionally be configured such that sending the user the positive reinforcement message or action includes sending the user a reward in the form of a credit, a point, a discounted item, or money.

In Example 18, the method of any one or any combination of Examples 16 or 17 can optionally be configured such that sending the user the positive reinforcement message or action includes sending the user a personalized audio, visual, tactile, or text message from a family member, caregiver, or friend.

In Example 19, the method of Example 15 can optionally be configured such that informing the user about compliance with the medication program includes initiating a negative reinforcement message or action.

In Example 20, the method of Example 19 can optionally be configured such that initiating the negative reinforcement message or action includes locking the portable device for all uses except emergency call use or limiting the patient's portable device so that only a limited number of calls can be made.

In Example 21, the method of any one or any combination of Examples 19 or 20 can optionally be configured such that initiating the negative reinforcement message or action includes at least one of increasing an insurance premium, increasing fees at a medical provider, or increasing fees at a pharmacy.

In Example 22, the systems or methods of any one or any combination of Examples 1-21 can optionally be configured such that all elements, operations, or other options recited are available to use or select from.

This Overview is intended to provide non-limiting examples of the subject matter of the present patent application. It is not intended to provide an exclusive or exhaustive explanation of the invention. The Detailed Description is included to provide further information about the present patent document.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates a medication compliance system flowchart, as constructed in accordance with at least one example.

FIG. 2 illustrates an isometric view of a medication compliance system, as constructed in accordance with at least one example.

FIG. 3 illustrates an isometric view of a medication module, as constructed in accordance with at least one example.

FIG. 4 illustrates an isometric view of a medication compliance system, as constructed in accordance with at least one example.

FIG. 5 illustrates a rear view of a medication compliance system, as constructed in accordance with at least one example.

FIGS. 6A and 6B illustrate side and rear schematic views of a cartridge type medication compliance system, as constructed in accordance with at least one example.

FIGS. 7A, 7B, 7C and 7D illustrate schematic views of a cartridge type medication compliance system, as constructed in accordance with at least one example.

FIGS. 8A and 8B illustrate side and front schematic views of a cartridge type medication compliance system, as constructed in accordance with at least one example.

FIGS. 9A, 9B, 9C, 9D, and 9E illustrate various configurations of medication compliance systems, each configuration as constructed in accordance with at least one example.

FIGS. 10A, 10B, 10C, 10D, and 10E illustrate side, front, and rear schematic views of various configurations of medication compliance systems, each configuration as constructed in accordance with at least one example.

FIGS. 11A, 11B, and 11C illustrate isometric, rear, and side views of a medication compliance system and a medication module, as constructed in accordance with at least one example.

FIG. 12 illustrates a medication compliance system including a mobile device, as constructed in accordance with at least one example.

FIGS. 13A, 13B, 13C, 13D, 13E, 13F, and 13G illustrate interactive display pages of a medication compliance program, as constructed in accordance with various examples.

FIGS. 14A, 14B, 14C, and 14D illustrate interactive display pages of a medication compliance program, as constructed in accordance with various examples.

### DETAILED DESCRIPTION

Medication compliance systems can include an automatic or self-propelled medication module configured to be connected to, and interact with, various types of portable devices. The portable devices can include cellular telephones, smart telephones, tablets, PDAs, radios, TVs, computers, or game consoles. A portable device can alert a patient, by way of a telephone call, an e-mail, a text message, or a calendar/alarm notification, for example, as to when to consume a medication dose stored in a medication module. A system can be in communication with a central medical provider database, which can register and track the number of times the portable device alerts the patient and the number of times the patient responds to the alert. Mechanisms of response to the alert can include, by way of example, opening or closing of a compartment of the medication module, a reply message (e.g., an e-mail, a telephone call, or a text) from the patient to a caregiver or the central medical provider database, or a recording means of detection (e.g., an optical arrangement, video tracking, or a photograph).

The system enables care providers and patients to manage medication compliance using hardware, firmware, or software applications that can be downloaded and installed into configured portable devices. An application can be configured to alert or remind a patient of a medication schedule and record when and how he/she responds to the alert. In various examples, if the patient fails to respond to the alert, an application can be configured to send a message to the care provider to check on the status of the patient and their medication in real time, lock the patient's portable device so that only emergency call access is operative, or limit the patient's portable device so that only a limited number of calls can be made. The alert or reminder can optionally be triggered only after a particular clinical threshold is met. For example, a caregiver can program a cancer patient's application to send a notice of non-compliance after only one or two missed doses (due to a higher risk of adverse event) versus more missed doses for diseases where non-compliance does not cause a significant adverse event. This algorithm can include changes in dose timing, frequency and other dose patterns, determined by the caregiver.

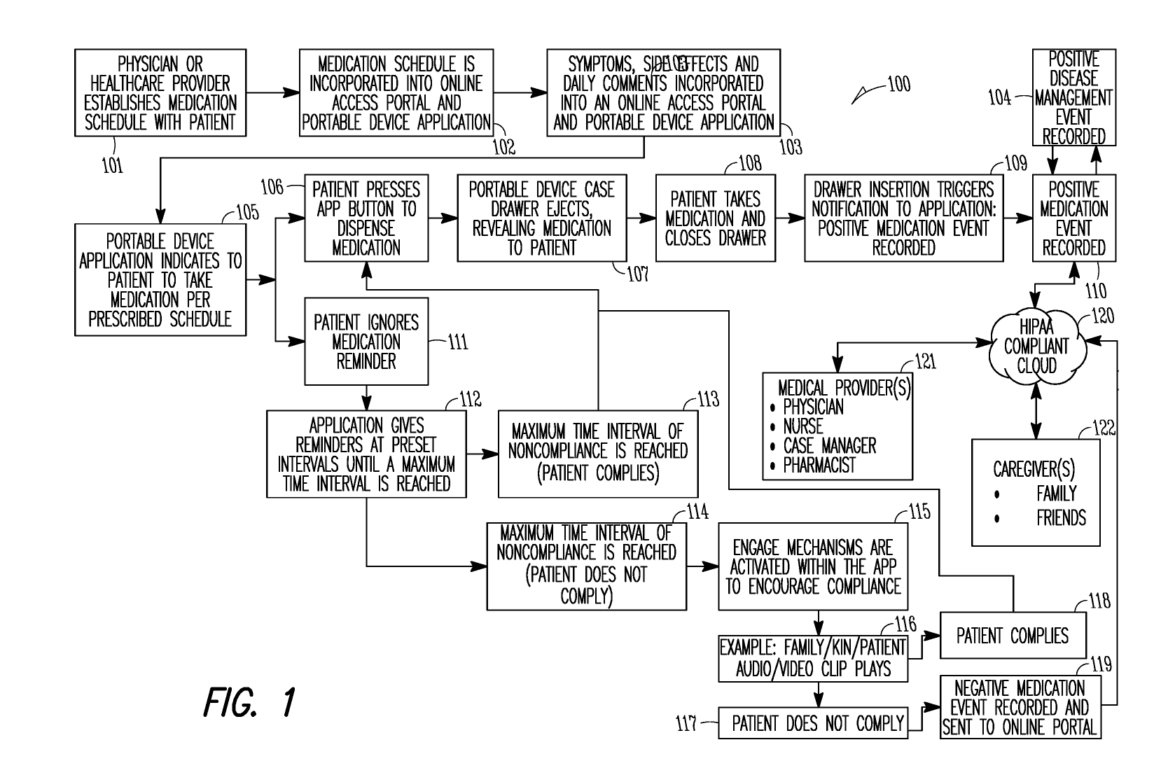

FIG. 1 illustrates a medication compliance system flowchart 100, which can be used to determine or track the extent to which patients consume medication doses as prescribed by their care providers. The system flowchart 100 illustrates relationships between a patient, a care provider (e.g., a physician, a nurse, an insurance provider, or a pharmacist), a medication module, a portable device, an online web portal, and a compliance software application.

At box 101, a care provider can establish a medication schedule for a patient. The medication schedule can be individualized, updated, or changed to fit a particular state of a patient, a particular schedule, or a particular medication. The patient or care provider can input patient information, such as name, date of birth, insurance information, or information about other prescribed medications, into a medical compliance software application. The care provider or patient can input information into the software application regarding a prescription, such as a medication, dosage, frequency, side effects, and instructional information. The care provider can also establish limits of non-compliance (e.g., how many missed doses represent an adverse event significant enough to notify the care provider or caregiver). The thresholds can be staggered by notification requirements. For example, if only a few doses are missed, under the threshold of missed doses set by the care provider, the software application can be set up to notify family members or immediate friends. After a more clinically impactful number of doses are missed (e.g., at or above an established threshold), the software application can be set up to notify the care giver. The software application can be tied to the National Institute of Health (NIH) or other nationally or internationally recognized database that can provide medication information.

The medication schedule can be communicated directly by the care provider to the patient or by electronic communication means, such as by telephone, e-mail, or text. The medication schedule can be directly incorporated into the software application and remain accessible to the care provider or caregiver for modification or updating. The medication schedule can be incorporated into an online access portal accessible by a portable device application at box 102.

From box 102, the system flowchart 100 can continue to box 103, where symptoms, side effects, and daily comments can be incorporated into the online access portal and the portable device application, and to box 105, where the portable device application indicates to the patient to consume a medication dose per the prescribed schedule. This indication can be in the form of a tactile, visual, or audio notification and can be configured to turn on a portable device that is powered off to provide the indication. The alert can be amplified by electronic circuitry incorporated into the medication module or the portable device.

From box 105, the patient can be provided with a choice between pressing an application button to dispense a medication or automatically receiving a dispensed medication from a medication module, at box 106, and ignoring the medication reminder, at box 111. If the patient chooses to dispense the medication at box 106, the portable device can initiate a medication module compartment to open, revealing a medication dose to the patient at box 107. The opening of the medication module compartment can be accomplished in many ways: a drawer can eject, a lid can open or indicate that it can be opened, a portion of a medication module case can rotate or unlock, or a patient or caregiver can manually open the medication module that is connected to the portable device.

At box 108, the patient can consume one or more doses of the medication and close the drawer or container lid of the medication module. The drawer or container lid closing can trigger a positive medication event notification at boxes 109 and 110. The drawer or container lid can be retracted manually or automatically based on a sensing element within the medication module. In an example, the medication module can contain any type of sensing means such as proximity sensors, infrared sensors, or cameras and can send information to a portable device regarding whether or not a medication container is full or empty or whether or not a patient has taken a medication. Any time an event is recorded in the medical compliance system, timestamps can accompany digital information.

The positive medication event recorded can be recorded as a positive disease management event (e.g., an event where the patient consumed the proper medication type, dose, etc. as prescribed by the care provider), at box 104, and can also be recorded in a Health Insurance Portability and Accountability Act (HIPPA) compliant cloud server, at cloud 120, which can enable one or more third parties to obtain access to the recorded event. The third parties can fall under two general groupings and all can be authorized in advance by the patient. Under the first grouping, at box 121, are care providers, such as physicians, nurses, case managers, and pharmacists. Under the second grouping, at box 122, are caregivers, such as family and friends.

If the patient chooses to ignore the medication reminder at box 111, the application can give reminders at preset intervals until a maximum time interval is reached at box 112. The preset intervals can be tailored to a particular patient, medication, or compliance program. At this juncture, the patient once again has a choice whether to comply and consume the medication or ignore the alert. If the patient chooses non-compliance, evidenced by a maximum time interval of non-compliance being reached at box 114, one or more engage mechanisms can be activated within the application to encourage compliance at box 115. These mechanisms can include an array of positive reinforcement messages or actions at box 116, such as pre-recorded audio, audio/video, or text messages involving the patient, caregivers, nurses, physicians, or other successful patients to encourage the patient to consume the medication. Positive reinforcement can also include an incentive program (e.g., credits, points, monetary value toward the patient's pharmacy bill or insurance premium rates, cash, or mile rewards). The positive reinforcement program can be updated through the use of historical compliance records and be tailored towards a successful compliance program. Should the patient be persuaded, he/she can comply with the medication schedule at box 118.

Should the patient not comply at box 117, a negative medication event can be recorded at box 119 and relayed to the HIPPA compliant cloud server at cloud 120. A non-compliance leading to a negative medication event can be tailored to a patient by altering numbers of alerts indicating non-compliance and varying time periods between alerts. The HIPPA compliant cloud server can be accessed by medical providers at box 121 and caregivers at box 122. The negative medication event, at box 119, can trigger negative reinforcement mechanisms, such as blocking outgoing calls or e-mails on the portable device, an immediate telephone call, text message or e-mail from a caregiver, or increased fees for insurance premiums, doctor visits or pharmacy refills. Optionally, the application can be programmed to require a threshold of negative medication events (e.g., two or three consecutive missed doses) to occur before the negative reinforcement mechanisms are triggered.

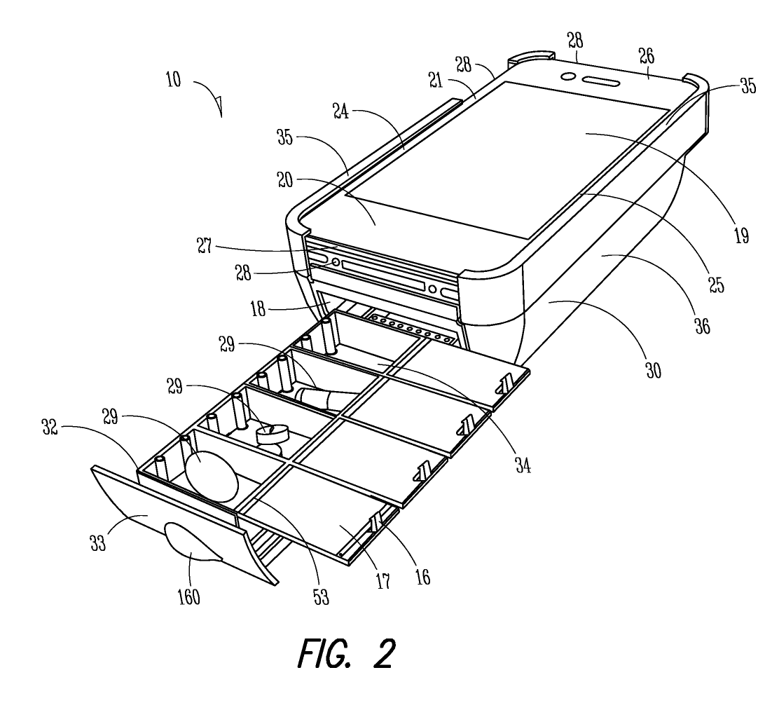

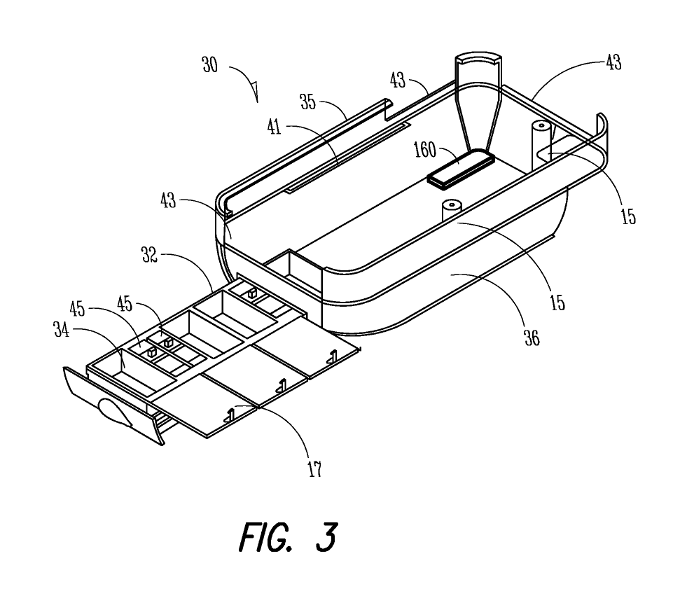

FIG. 2 illustrates an example of a medical compliance system 10. The medical compliance system 10 can include a portable device 20 and a medication module 30. As shown in this example, the portable device 20 and the medication module 30 can be affixed to each other and electrically connected wirelessly or via a wired connection. Alternatively, the portable device 20 and the medication module 30 can be remote from one another and electrically coupled using a wireless connection. A wired or wireless connection can be formed from the medication module 30 to the portable device 20 through a communication module 160 (see FIG. 3). The wireless connection can be a wireless link such as Bluetooth, proximal telemetry, inductive telemetry, infrared telemetry, or Radio Frequency (RF) telemetry. The wired connection can be a wired link, such as an audio jack or data port.

The portable device 20 can be any device containing an electronic communication module 21, such as a cellular telephone, a smart telephone, a computer, a TV, a personal digital assistant, a tablet, a radio, or a game console. The electronic communication module 21 can be capable of receiving and transmitting electronic signals from the medication module 30 and can receive and transmit electronic signals with online web servers. The portable device 20 can display, alert, or signal by tactile, audio, video, text, e-mail or other alarm means. The portable device 20 can have a front face 22 including a display 19, an opposing rear face, a top side 26, a bottom side 27, a left side 24, and a right side 25. The sides can be defined and connected by an outer edge 28. The portable device 20 can include real or virtual alphanumeric keys. The portable device 20 can provide a user interface for a medication compliance system as in FIG. 1.

The medication module 30 can take the form of a protective case 36 that permanently or temporarily retains the portable device 20. The case 36 can be manufactured to any portable device 20 specifications and can allow passive placement of the portable device 20 into the case 36 by “popping” in the device 20 with a small amount of force. For example, the case 36 can include a retaining rim member 35 configured to flex enough to allow the portable device 20 to be inserted and retained securely. Other retaining methods can include enclosures or other snap features. The medication module 30 can be disposable and include pre-loaded medications. The medication module 30 can be made from a wide range of materials or combinations of materials such as metals, plastics, polyurethanes, rubber, fabrics, fiberglass or composites.

The medication module 30 can include an opening 18 through which a drawer 32 or other compartment can be allowed to slide in and out. The drawer 32 can include one or more compartments 34 for storing medications 29 in the form of pills, powders, or liquids and the compartments 34 can be spill and leak proof. The drawer 32 can include a door 33 having a drawer handle 160 and can fit flush with the medication module 30 when the drawer 32 is in a closed position. Although the opening 18 is illustrated as located on a bottom side of the medication module 30 retaining the bottom 27 of the portable device 20, the opening 18 can be located anywhere in the medication module 30 including the left side, right side, top or rear. The medication module 30 can have more than one opening 18 and more than one drawer 32.

One or more compartments 34 of the medication module 30 can have a lid 17 that can prevent medications 29 from falling out of the compartments 34. The lid 17 can be opened and closed using a hinge 53. The lid 17 can also be configured as a sliding member located between rails or other retaining means. The lid 17 can include a latch member 16 formed to provide a secure connection between the lid 17 and the compartments 34. The latch mechanism can include pins, magnets, straps, latches or other means of securing the lid 17 to the compartment 34.

FIG. 3 illustrates an isometric view of a medication module 30. A drawer 32 can include one or more compartments 34, in which a micro-switch 43 can be located. The micro-switch 43 can be connected to a portable device 20 (see, e.g., FIG. 2) and can automatically indicate whether a lid 17 has been opened or closed. The opening or closing of the lid 17 can be used as an indication that a dose of medication has been dispensed to a patient. The micro-switch 43 is an example of sensing means. Other means of sensing whether or not a dose of medication has been dispensed to the patient can also be present, including proximity sensors, infrared sensors, or cameras. The sensing means can send information to the portable device 20 regarding whether or not a compartment 34 is full or empty. Video or photo capture mechanisms in the portable device 20 can also be utilized to show the patient consuming a dose of medication. A sensor can be located in the compartment 34 or in the medication module 30 within sensing range of the compartment 34. Depending on the configuration of the medication module 30, a medication taking event or activity can be sensed as an opening or closing of a compartment 34, a compartment 34 changing from full to empty, or a captured image of a patient taking a medication. A communication module 160 is illustrated as located in the bottom of the case 36, however the communication module 160 can be located anywhere on the medication module 30. In an example of a wireless connection, the communication module 160 can be a Bluetooth circuit board or other means as described above. In an example, the communication module 160 can be a connector for a wired connection to a portable device 20.

The medication module 30 can include a resting ledge 41 or post supports 15 configured to engage and support a rear face of the portable device 20. The medication module 30 can include numerous cut outs 43 that are located so that features of the portable device 20, such as connection ports, volume controls, and cameras, are accessible.

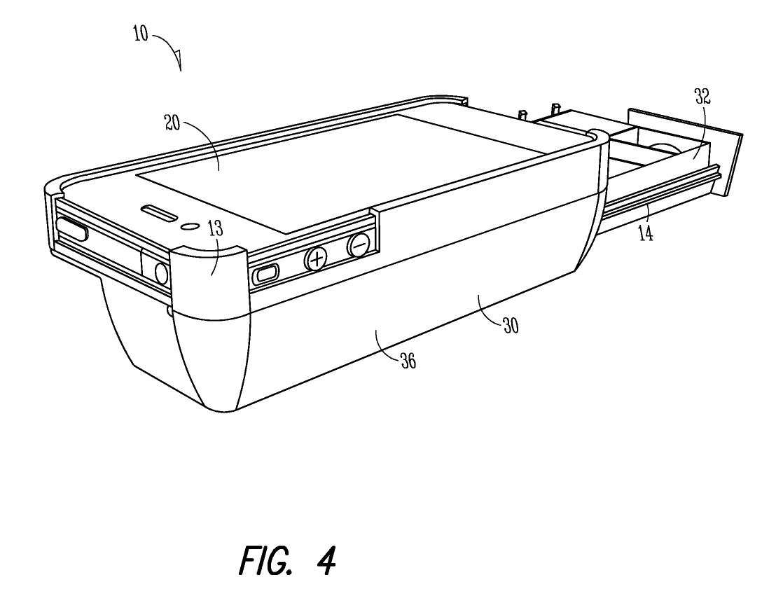

FIG. 4 illustrates an isometric view of a side of a medical compliance system 10, including a medication module 30 and a portable device 20. A slide rail 14 can extend along a side of a drawer 32 and can be used to allow the drawer 32 to slide in and out of the medication module 30. In an example, the drawer 32 can be motorized and the slide rail 14 can include teeth for engaging motorized gears. Any type of motorized mechanism can be used to automatically open and close the drawer 32.

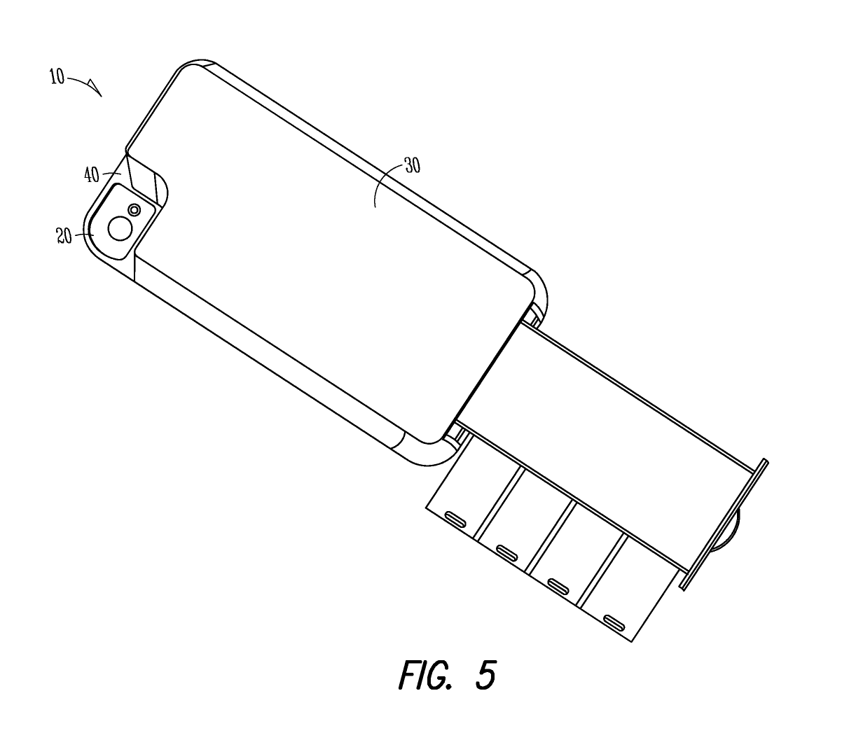

The medication module 30 can have contoured corners 13 to provide an aesthetically pleasing and utilitarian shape to the system 10. The medication module 30 can also have contoured gripping shapes along sides and rear faces to allow a patient to better grip the medical compliance system 10. FIG. 5 is an isometric illustration of a rear side of a medical compliance system 10. A cut out 40 in the medication module 30 can allow a camera or imaging feature of the portable device 20 with unobstructed accessibility.

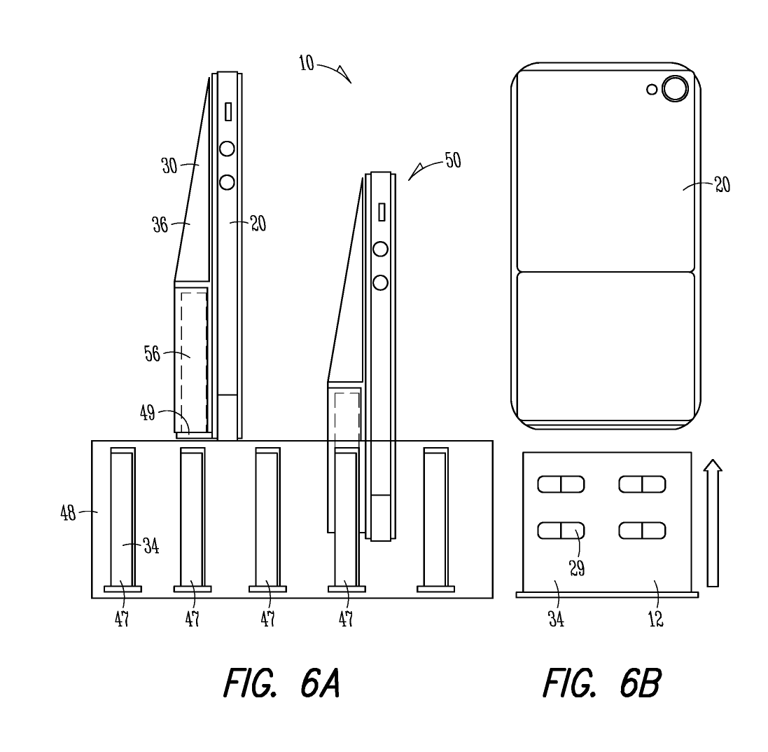

FIGS. 6A and 6B illustrate side and rear schematic views, respectively, of another example of a medication compliance system 10. In this example, a medication module 30 utilizes at least one removable storage element or cartridge 47. The cartridge 47 can include one or more compartments 34 configured to hold one or more doses of medications 29. The cartridges 47 can be pre-loaded with daily or weekly doses 12 and can be received into a cartridge cavity 56 of the medication module 30. The medication module 30 can include one or a plurality of cartridge cavities 56.

A plurality of cartridges 47 can be located in a base station 48 and loaded into the medication module 30 by a loading technique 50. The loading technique 50 can include hovering the medication module 30 over a cartridge 47 and pressing the module down onto the cartridge 47 or otherwise allowing the cartridge 47 to move into a cartridge cavity 56. The cartridge 47 can move into the cartridge cavity 56 through a configuration of magnets on either or both of the cartridge cavity 56 or the cartridge 47. In another example, the cartridge cavity 56 can have a motorized loader akin to a compact disc loading mechanism.

Each cartridge 47 can be retained in the cartridge cavity 56 by an interference fit (e.g., the cartridge 47 can be pressed into the cartridge cavity 56 area and, due to a dimensional tolerance stack-up, is retained passively), magnetic coupling (e.g., a magnet embedded within each of the module 30 and the cartridge 47), a one-way entry mechanism (e.g., a pin mechanism that can be pushed in or retracted when the cartridge 47 is placed into the cartridge cavity 56 and then deployed to retain the cartridge 47), or mating male/female or interlocking structures. Upon a subsequent actuation, any cartridge retaining means can dislodge, eject, or retract to allow the cartridge 47 to be removed from the module 30.

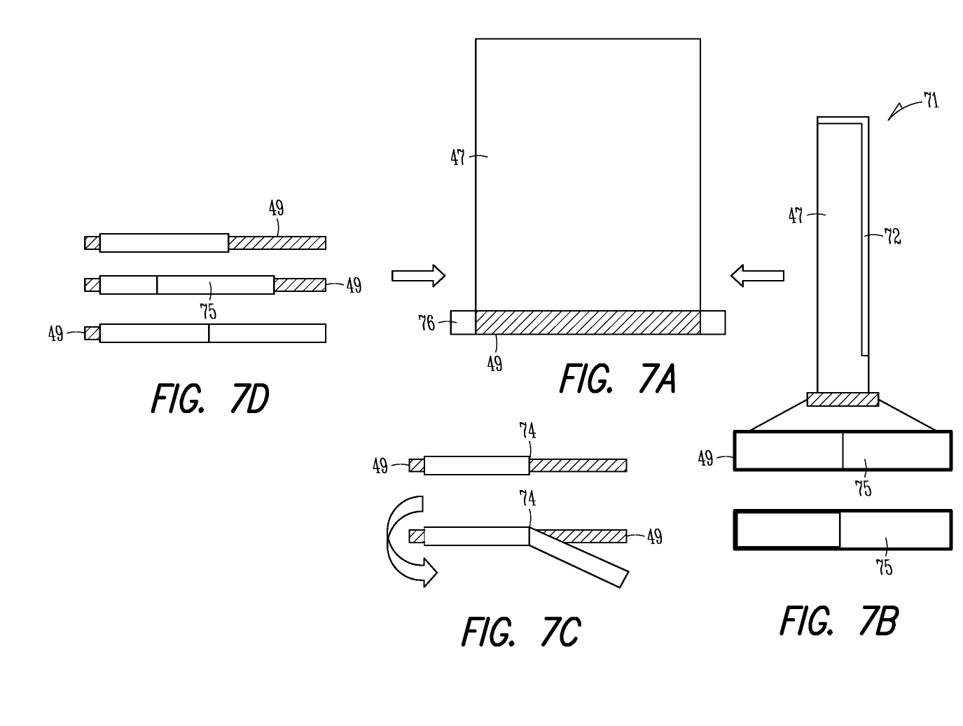

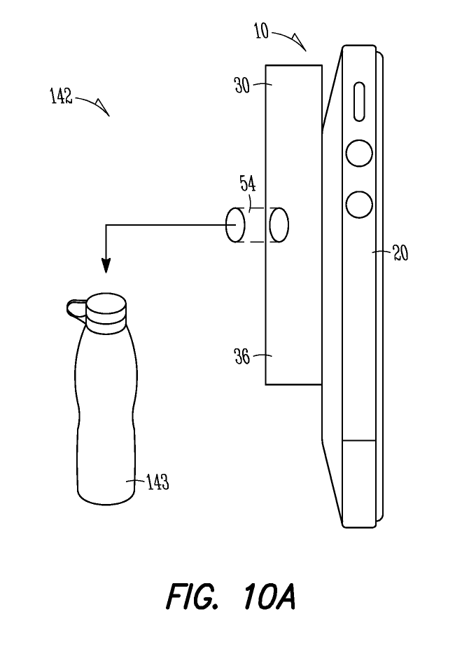

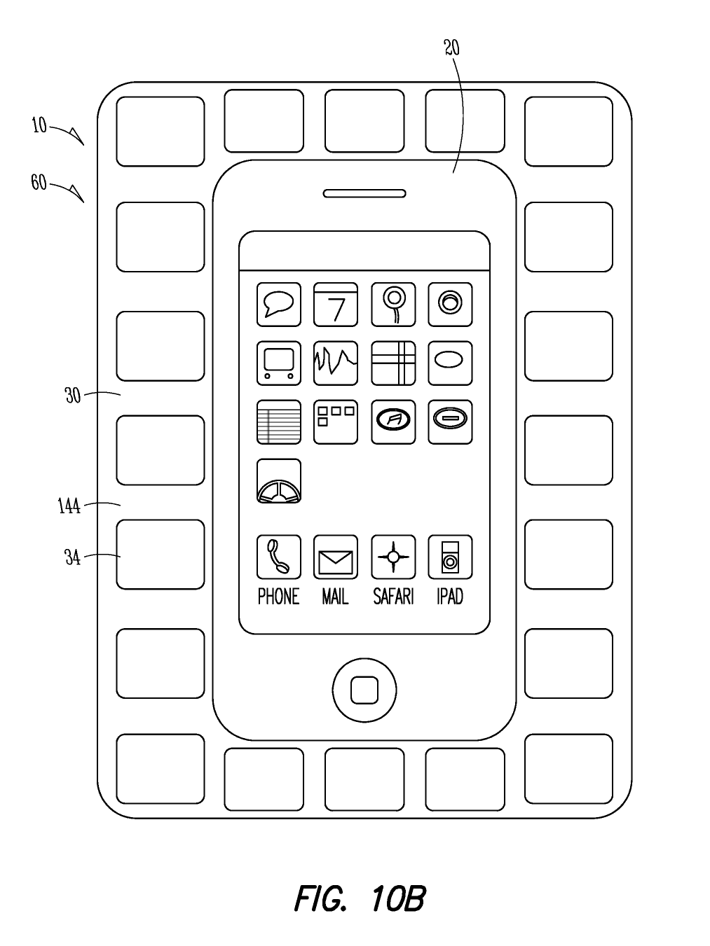

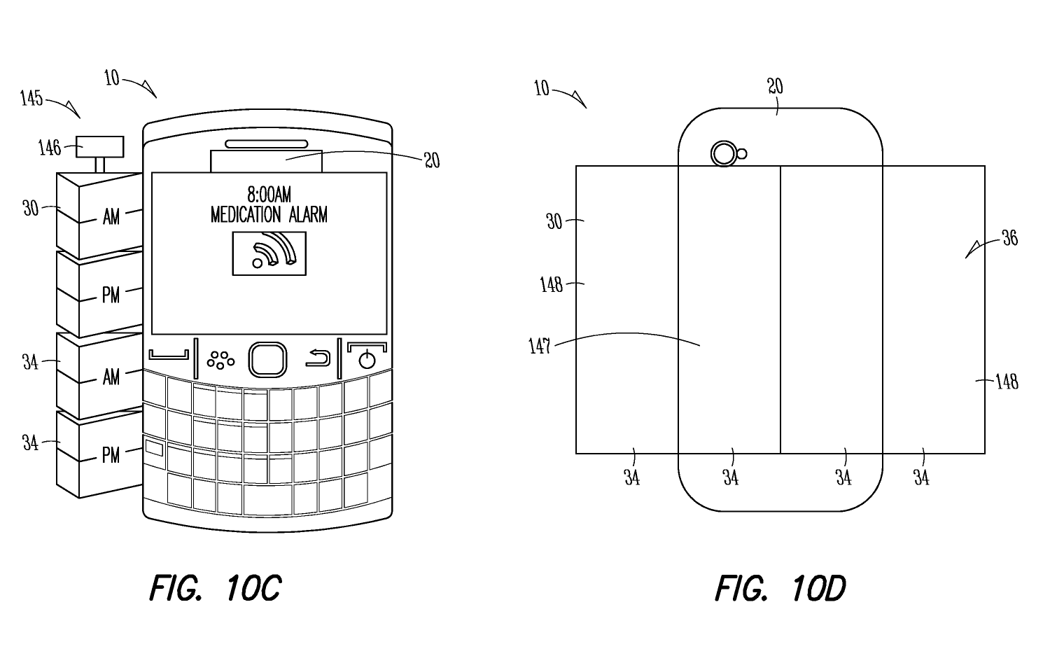

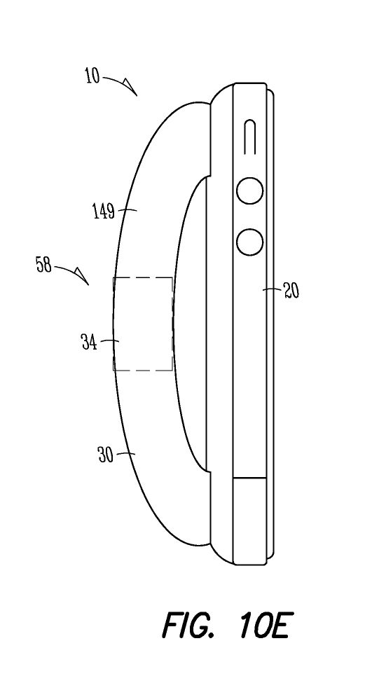

FIGS. 7A, 7B, and 7C illustrate a door 49 feature of a cartridge type medication dispensing system. FIG. 7A illustrates a top view 70 of a cartridge 47 and FIG. 7B illustrates a side view 71 of the cartridge 47. The door 49 can be included at an end of a medication module 30 (see, e.g., FIGS. 6A and 6B). The door 49 can provide an opening to dispense one or more doses of medication. The door 49 can have a hinge 74 to swing open, as shown in FIG. 7C, or a sliding panel 75 movable back and forth to dispense one or more doses of medications, as shown in FIG. 7D. The opening of the door 49 can be actuated by a push/release button 76 or buttons on the sides of the door 49. The door 49 can include a collapsible spout (see, e.g., FIG. 10) for dispensing liquid or powder medications.

Cartridge type medication dispensing systems can include other features as well. For example, the cartridge 47 can have an acrylic or transparent top panel 72, which can allow medications to be viewed by a patient or care provider. The cartridge 47 can operate as a sliding drawer, either motorized or manual. The cartridge 47 can be configured to have a lid opening on the top panel 72. Access to the cartridge 47 can be controlled by a portable device 20 in communication with a medication module 30.

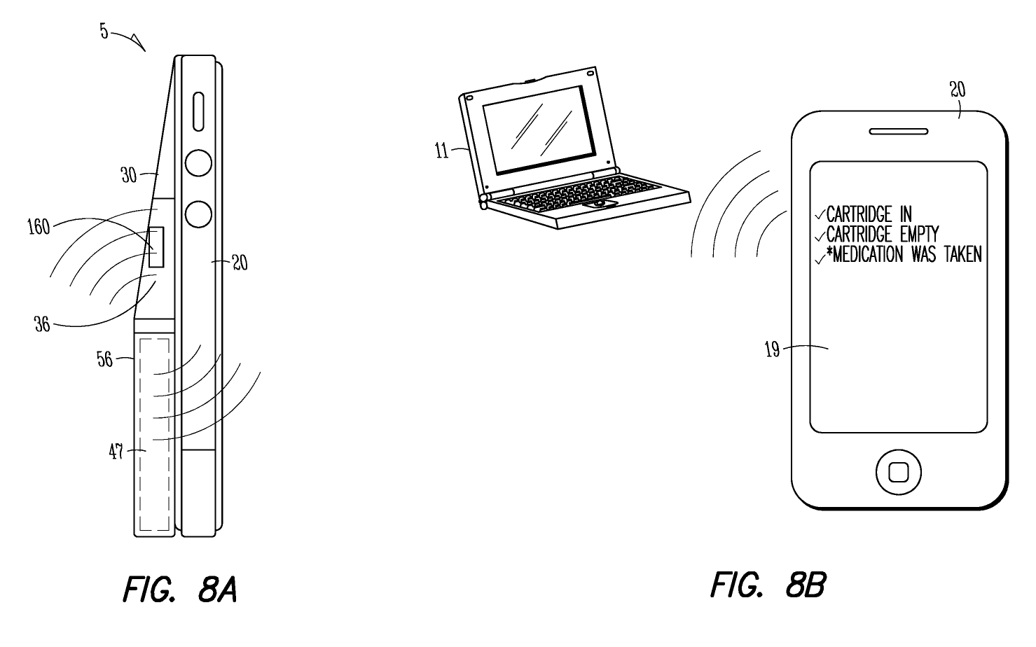

FIGS. 8A and 8B illustrate operations of a medication compliance system 5 including a medication module 30, a portable device 20, and an online web portal 11. The medication module 30 can include one or more sensors that can determine if a cartridge 47 is loaded into the module. The medication module 30 can include one or more sensors configured to determine if the cartridge 47 is empty or full. These sensing means can include proximity sensors, infrared sensors, or cameras and can send information to the portable device 20 regarding whether or not the cartridge 47 is full or empty. The medication module 30 can include a communication module 160. Sensed information can be transmitted from sensing means to the communication module 160 and can then be transmitted from the communication module 160 to a portable device 20. Sensed information can be displayed on a display 19 of the portable device 20 with messages such as “Cartridge in”, “Cartridge empty,” or “Medication was taken/consumed”. These messages can be transmitted to the online web portal 11 by a medication compliance software application, as initially disclosed in FIG. 1 and the associated text, so that third parties (e.g., physicians, nurses, care providers, or caregivers) can be made aware of compliance or non-compliance with a medication program.

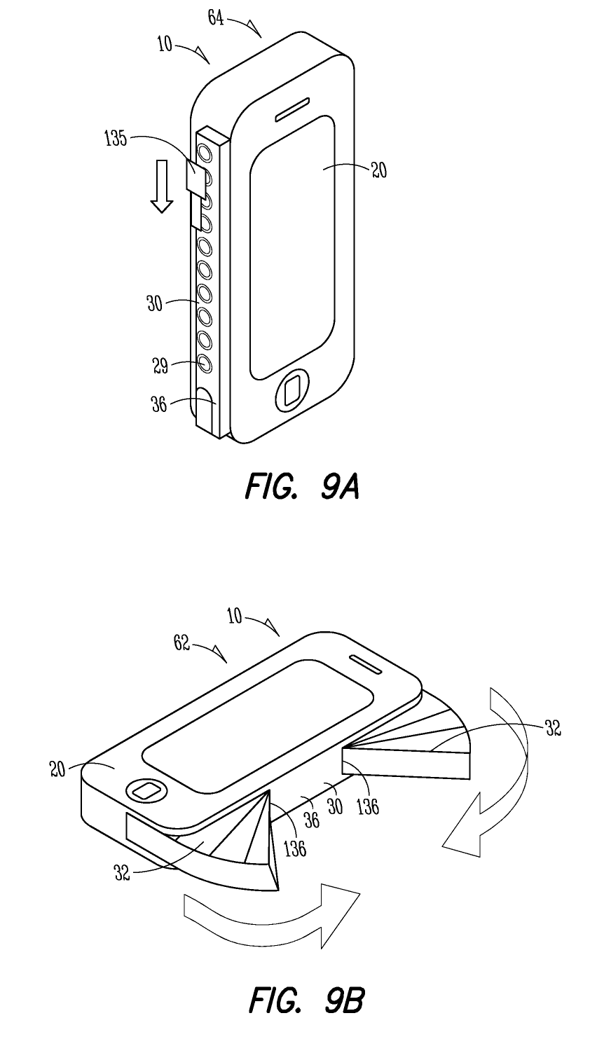

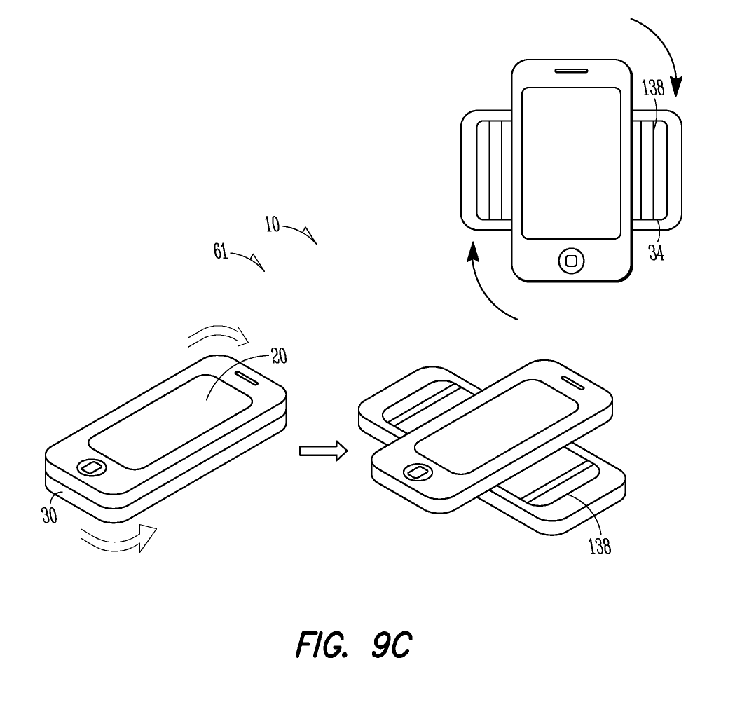

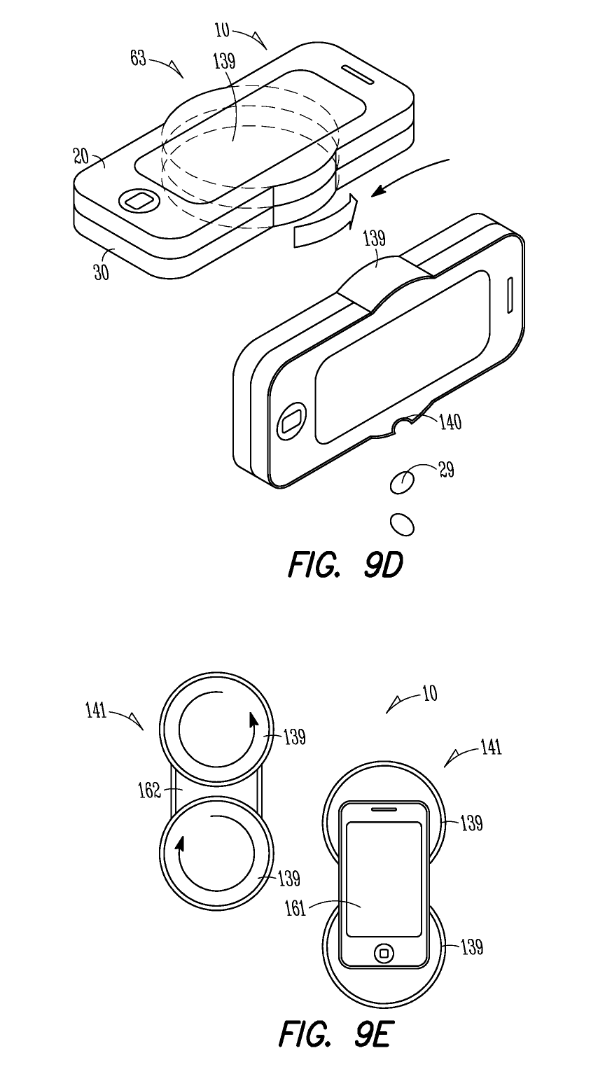

FIGS. 9A, 9B, 9C, 9D, and 9E illustrate various examples of configurations of medication compliance systems 10 including a medication module 30 and a portable device 20. As shown in FIG. 9A, a stacked medication dispenser system 64 can include a medication module 30 in the form of a case 36. The case 36 can be affixed to a portable device 20. Doses of medication 29 can be in a stacked linear arrangement and a sliding dispensing member 135 can actuate a medication dispensing activity. Dispensing members can be spring loaded, manual, motorized, or controlled by pressing a button on the portable device.

FIG. 9B illustrates a rotating drawer dispenser 62 of a medication module 30. The medication module 30 can be in the form of a case 36 and attached to the bottom of a portable device 20. One or more drawers 32 can swing out from the case 36 in a rotating movement to provide access to medication doses. The drawer 32 can be attached at a pivot point 136 in the case 36.

FIG. 9C illustrates a pivoting case dispenser 61 of a medication module 30 with a two part case 137 and attached to the back side of a portable device 20. The two part case 137 can include an upper portion, attached to the portable device 20, and a lower portion 138 that has a centralized pivot point and is able to rotate up to 360 degrees from the upper portion. The rotation can reveal one or more compartments 34 of the medication module 30 containing medication doses.

FIG. 9D illustrates a wheel cartridge dispenser 63. The dispenser 63 can include a round cartridge 139 insertable into a medication module 30, which can be affixed to the back of a portable device 20. The round cartridge 139 can be disposable or refillable and can have one or more openings 140 that allow medications 29 to be dispensed when the wheel cartridge dispenser 63 is tipped. The round cartridge 139 can have separate compartments, such as one compartment for daytime medications and one compartment for nighttime medications.

FIG. 9E illustrates a front 161 and a back 162 side of a medication compliance system 10 including a two wheeled cartridge dispenser 141. The two wheeled cartridge dispenser 141 can operate in a similar manner as the wheel cartridge dispenser 63 of FIG. 9D and can have two round cartridges 139.

FIGS. 10A, 10B, 10C, 10D, and 10E illustrates various examples of configurations of medication compliance systems 10 including a medication module 30 and a portable device 20. As shown in FIG. 10A, a system 10 can include a liquid/powder dispenser 142 having an extendable-retractable spout 54. The spout 54 can be coupled to, or integrated with, a portion of a medication module 30 in the form of a case 36. The case 36 can be attached to a portable device 20. The spout 54 can provide an easy method of pouring a powder or liquid medication into a bottle 143 or other container. The spout 54 can optionally be included in any of the medication compliance systems 10 disclosed in this patent document.

FIG. 10B illustrates a medication compliance system 10 including a medication module 30 that surrounds or forms a perimeter of a portable device 20. The medication module 30 can include a surrounding case 144 having a plurality of compartments 34 to store medication doses. The compartments 34 can be labeled with “A.M.” and “P.M.” or days of a week to organize a patient's medication schedule.

FIG. 10C illustrates a medication compliance system 10 including a side mounted 145 medication module 30 attached to a side of a portable device 20. The medication module 30 can include one or more compartments 34 and can have a release button 146 to open or close the compartments 34.

FIG. 10D illustrates a medication compliance system 10 including a medication module 30 that is formed of a compliant mesh material 147. The medication module 30 can be in the form of a case 36 having one or more compartments 34. The compliant mesh material 147 can be collapsible and can be locked into ‘closed’ configuration in multiple ways (clasp, band, etc.). The compliant mesh material 147 can stretch when medication doses are loaded into the compartments 34. The compliant mesh material 147 can include folding elements 148 that can be arranged many ways for space reduction.

FIG. 10E illustrates a medication compliance system 10 including a medication module 30 in the form of a case 36. The case 36 can be shaped in the form of a handle 149 that projects from a portable device 20. The projection can be tubular, rectangular or any other shape and can be attached to a molded enclosure for the portable device 20. This design can be easy to use and can be recognized by an elderly population as a handle shape similar to older phones. Medication dose storage within the handle 149 can be throughout the handle 149 with a dispensing opening embedded along the handle 149. Alternatively, there can be one or more defined compartments 34 within the handle 149 for medication dose storage.

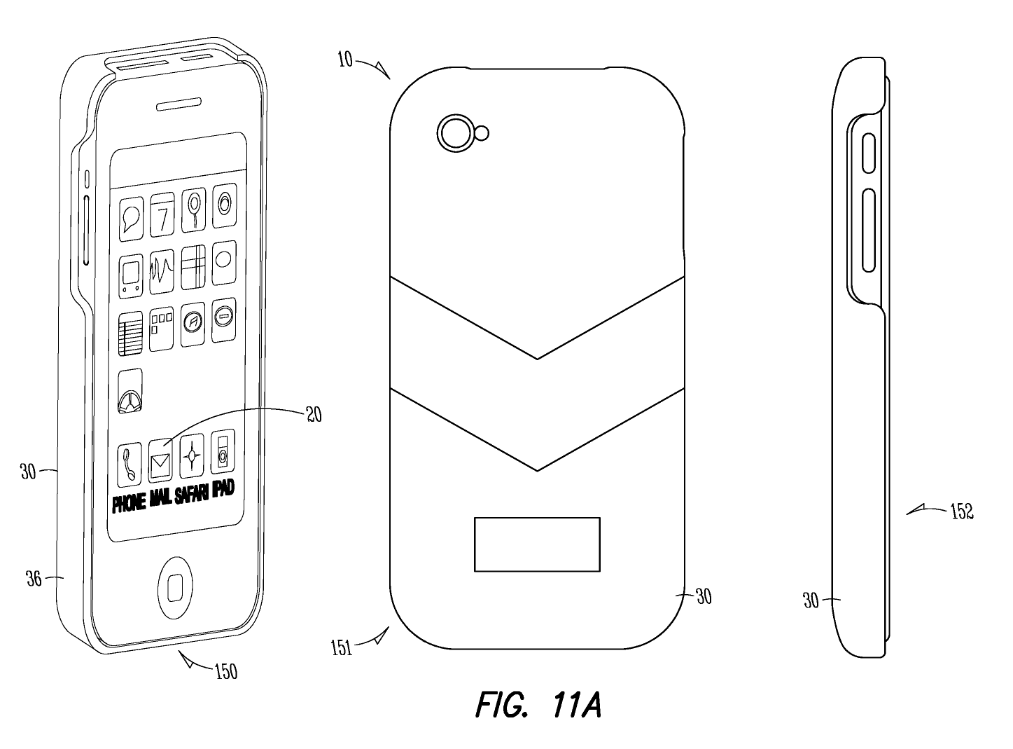

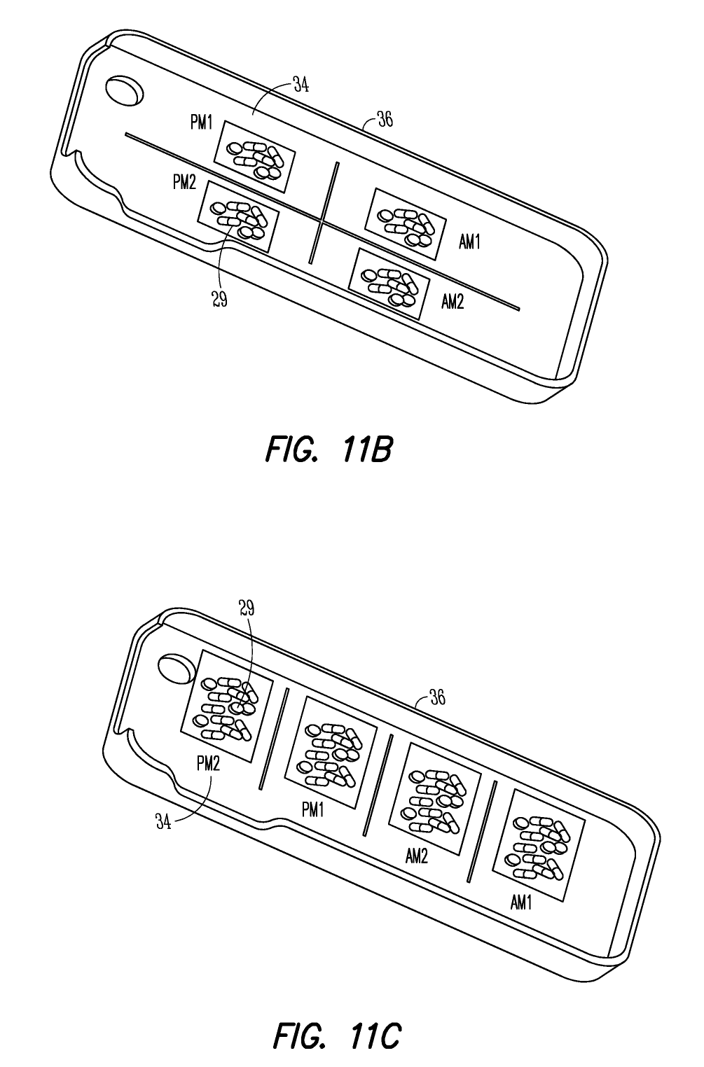

FIGS. 11A, 11B, and 11C illustrate another example of a medication compliance system 10. The medication compliance system 10 is shown in a front view 150, a rear view 151, and a side view 152 in FIG. 11A. As shown in FIGS. 11B and 11C, a medication module 30 can include a case 36 that adheres to a back portion of a portable device 20. The case 36 can include one or more compartments 34 configured to contain one or more medication doses 29. The medication doses 29 can be in the form of pill pouches or boxes configured so that a patient need not touch the pills for hygiene purposes. The patient can dispense a medication dose and, when depleted, dispose of the pouches, boxes, or pill containers.

The medication module 30 included in any of the medication compliance systems 10 disclosed in this patent document can include a wireless link such as Bluetooth, proximal telemetry, inductive telemetry, infrared telemetry, or RF telemetry having the ability to connect to the portable device 20. The medication module 30 in any of the medication compliance systems 10 disclosed in this patent document can be configured to couple with a software application package residing in, or connectable to, the portable device 20, which can wake after informing a patient that it is time to consume a medication dose 29. The medication module 30 can include a separate back ‘slip’ or ‘pocket’ that opens up and is configured to dispense medication doses 29 by a sliding movement or folding open as in a book case to reveal one or more compartments 34.

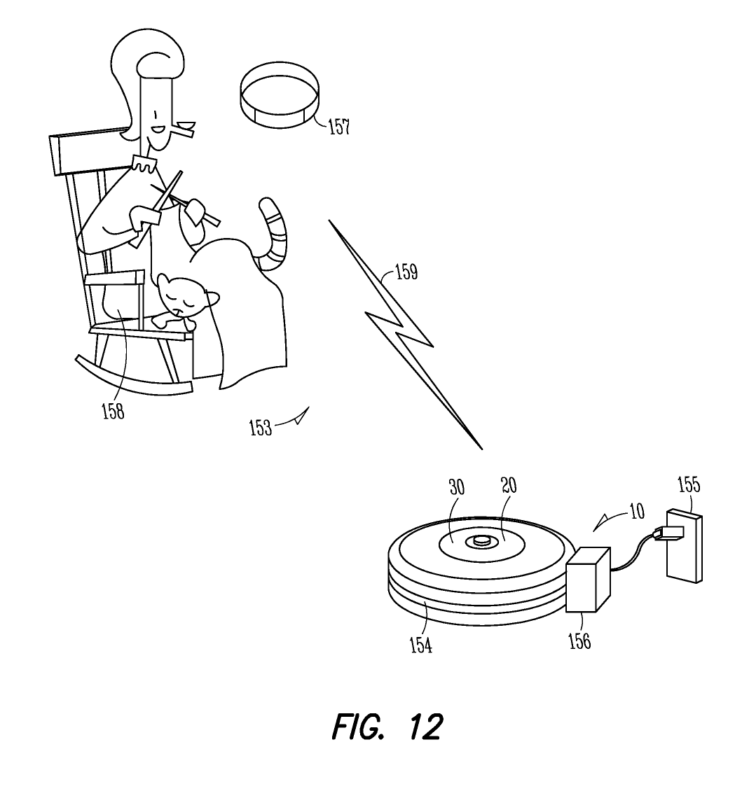

FIG. 12 illustrates a mobile medication module system 153. The system 153 can include a mobile device 154, a radio frequency identification (RFID) tag 157, a wireless link 159, a charging station 156, a power generation means (e.g., an outlet 155), and a medication module 30. The medication module 30 can be connected to a portable device 20, as discussed and illustrated in FIGS. 2-11, and form a medication compliance system 10.

The mobile device 154 can include a receptacle to hold the medication module 30 and can be configured with wheels, legs, tracks or other means to transport the medication module 30 from one location to another. The mobile device 154 can include robotic configurations. A patient 158 can wear an RFID tag 157 connected by a wireless link 159 to the mobile device 154. The mobile device 154 can be connected to the medication module 30. The mobile device 154 can be configured to receive a signal from a portable device 20 or the medication module 30 concerning a medication schedule of the patient 158. By tracking an RFID signal emitted from the RFID tag 157, the mobile device 154 can transport the medication module 30 to the location of the patient 158. The charging station 156 can be plugged into an outlet 155 and can be a resting location or home base for the mobile device 154. The mobile device 154 can be configured to recharge the RFID tag 157.

The medication compliance systems 10 disclosed in this patent document can include a medication module 30 having a miniature onboard motor. The onboard motor can be actuated from the portable device 20 directly via a relay switch. For example, once a reminder arrives to the portable device 20 through an application and the patient presses a command, an ejection mechanism can be actuated through a signal from the portable device 20 to an onboard Bluetooth in the medication module 30, which can trigger a mechanical ejection event. These mechanisms may have a corresponding tactile, audio, or visual output once actuated. For example, upon ejection, a built-in light LED, for example, can be triggered by an onboard relay from the portable device 20 application or coupled to the mechanical ejection mechanism to signal that a medication is available for use. These cues may also serve as a reminder to the patient to consume a medication dose.

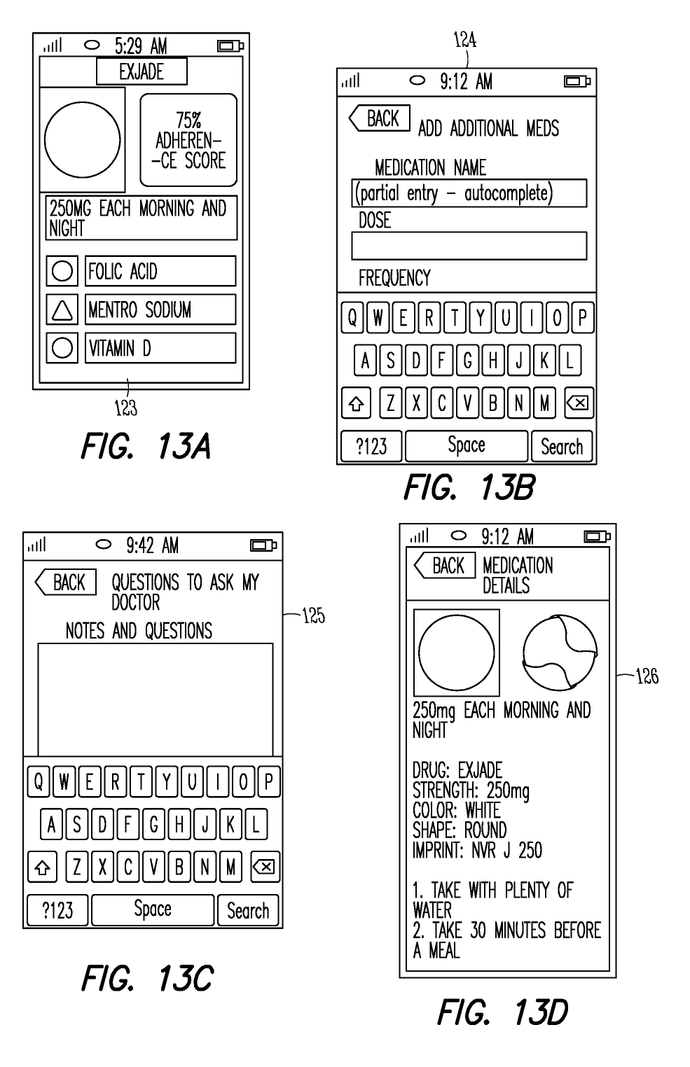

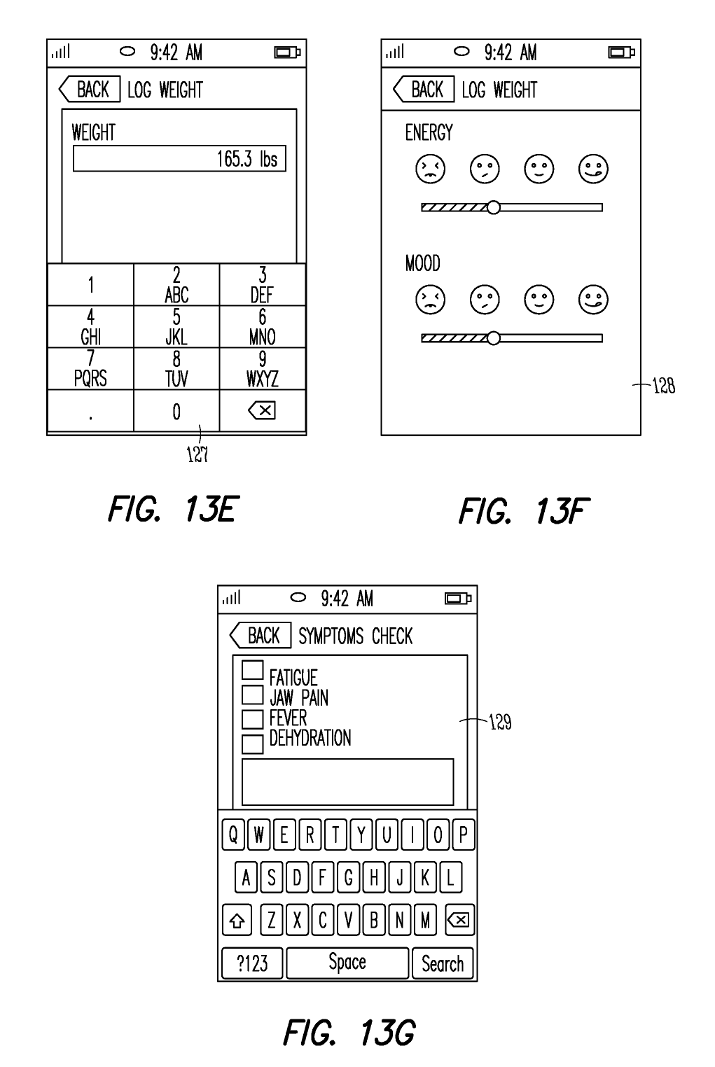

A software application downloaded onto a portable device 20 (see, e.g., FIGS. 1-12) can include informational, interactive, educational, and input displays such as the display pages illustrated in FIGS. 13A, 13B, 13C, 13D, 13E, 13F, and 13G.

Page 123 can include a multi-medication and adherence score and can indicate information to a patient about multiple medications he/she is taking. The adherence score can be a score generated by a software application algorithm that expresses a degree of compliance with a medication program.

Page 124 can include a display that allows a patient to add a medication to his/her medication compliance program. The compliance system can be programmed to require patient's authorization to be viewed, accessed or manipulated by third parties, such as care providers and caregivers. Patients can authorize third parties, located at remote terminals, to update their compliance program with new medications, new dosages or other pertinent information.

Page 125 include a notes and questions portal, which can allow a patient to ask questions of care providers or caregivers connected through the software application. A similar page can display answers, texts, and e-mails from a live individual or from a database of information.

Page 126 can include medication dose details, such as a description of a pill including color, shape, imprinted marks or identifiers, strength and dosages. The page can also include directions about how and when to consume the medication dose.

Display pages 127, 128, and 129 can include information that can indicate an effectiveness of a medication and correlate the effectiveness to adherence or compliance with a medication compliance program. The patient can log their weight at page 127, indicate how he/she feels, with mood and energy ratings at page 128, and keep track of any symptoms or side effects that they are experiencing at page 129, such as fatigue, abdominal pain, fever, headaches, irregular heartbeats, joint pain, irregular blood sugar or blood pressure. These results can be monitored by a care provider and the patient can be contacted if any danger signals or non-compliance events are recognized.

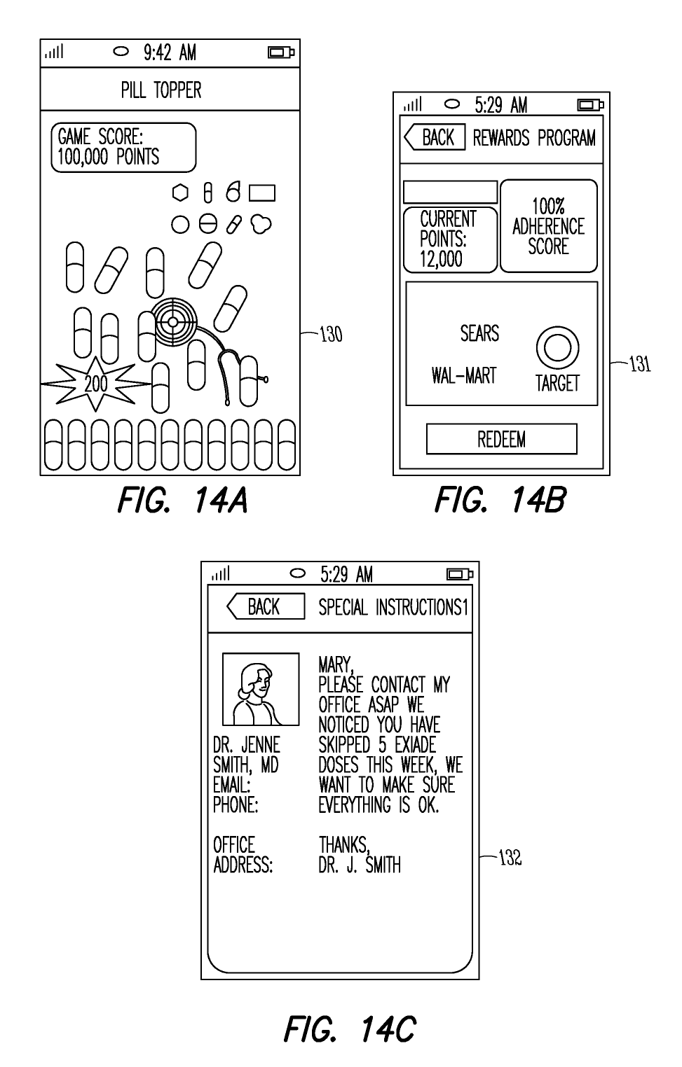

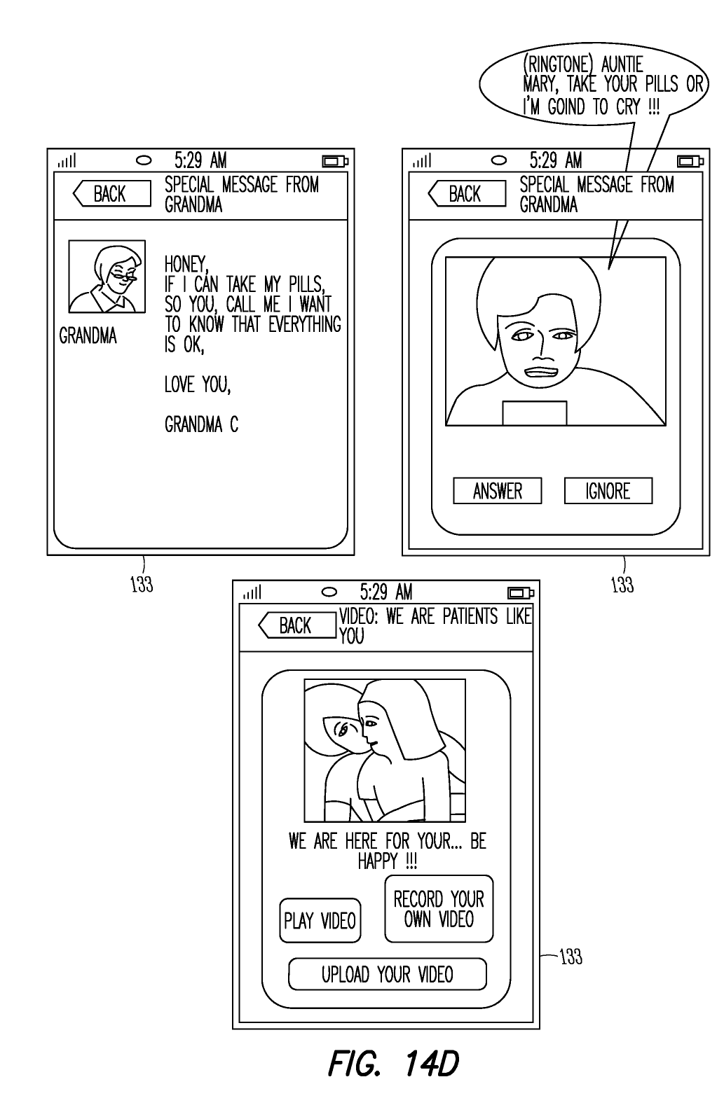

FIGS. 14A, 14B, 14C, and 14D illustrate additional display pages that can be maintained or created by a medication compliance application program. The pages can relate to incentive programs or interactions with care providers or caregivers.

Page 130 displays an incentivized game that can be geared towards children patients. The game can require a patient to complete a series of challenges before a medication dose is dispensed, thereby encouraging compliance with a medication program.

The compliance program can be connected to rewards programs available from retailers. Page 131 displays an indication of a patient's adherence score. The patient can earn points redeemable for discounts, prizes, movie tickets and the like at popular retailers. The program can be connected to catalogs of redeemable merchandise or services.

Page 132 illustrates an example of an interactive experience between a care provider and a patient. In this example, the care provider has contacted a patient due to poor compliance with his/her medication program. The care provider can make deductions from compliance behavior and alter, reduce or discontinue a medication program that is not working. The care provider can use the software to educate the patient on consequences of poor compliance with a drug that he/she needs to consume. Caregivers, such as family and friends, can also be authorized to view compliance information and can provide congratulatory, inspiring or even nagging messages to psychologically influence the patient to comply with the program as shown at page 133. These messages can be in the form of audio, video, tactile sensation, or text and can be displayed on, or produced by, a portable device 20.

Medication compliance can be influenced by a patient's psychological state. A patient's willingness to consume a medication dose will improve compliance. In an example, a short video can be presented on a patient's portable device upon activation of a medication alarm. The video, when presented on a screen of a user's device, can empower the psychological state from within which influences their willingness to consume the medication dose. The video can be from a patient sharing his/her experiences on importance of taking medication doses on time. The video content can be customized to many aspects of the patient, for example, patient demographics, play time of video, choice of voice, male versus female, ethnicity, language, customized privacy settings, integration with social networking, etc. A collection database of randomly selected videos can be performed in which the content selections are made by the patient or their care provider. In an example, rather than a video with an audio track, an audio track alone is presented to a user as a prompt. The audio can be selected randomly from a library or a pre-programmed choice can be presented to the user.

In an example, a portable device can be integrated with a wireless router that is connected with a television (TV) antenna. The portable device can be configured to remind a patient to consume medicine doses on a TV screen. Even when off, the portable device can be configured to power on the TV and present a message (audio, video, or both audio and video) to inform the patient to consume a medication dose. The portable device can be connected to a TV or to a gaming device, such as an Xbox, PlayStation, Wii, etc.

Optionally, the medication module 30 as described in FIGS. 1-12 can take the form of a wrist watch, a wearable garment (for example, a belt, a hat, a chest vest), a pill pouch integrated with a portable device 20 cover, a clip that affixes to a wallet, a pen-sized or pen-based dispenser device, an electronic key chain medication module 30 communicates with the portable device 20, or a base or attachment integrated with daily use utensils, such as a water bottle, a beverage mug, a beverage glass, etc. The medication module 30 can include a base in a utensil, for example a lid, a handle, a slip-on holder which houses the medication. Other examples of a medication module 30 can take the form of a beverage glass or mug container with a built-in electronic clock that changes color or generates an audible alarm to inform the patient to consume a medication dose. The medication module 30 can alternatively be attached to a mobilization device, such as a cane, walker or wheelchair, or attached to a chest pin (for example, a broach, a decorative pin, or a name tag).

The above Detailed Description includes references to the accompanying drawings, which form a part of the Detailed Description. The drawings show, by way of illustration, specific embodiments in which the present medical compliance systems and methods can be practiced. These embodiments are also referred to herein as “examples.”

The above Detailed Description is intended to be illustrative, and not restrictive. For example, the above-described examples (or one or more elements thereof) can be used in combination with each other. Other embodiments can be used, such as by one of ordinary skill in the art upon reviewing the above description. Also, various features or elements can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description, with each claim standing on its own as a separate embodiment. The scope of the invention should be determined with reference to the appended claims, along with the full scope of equivalents to which such claims are entitled.

In this document, the terms “a” or “an” are used to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated.

In the appended claims, the terms “including” and “in which” are used as the plain-English equivalents of the respective terms “comprising” and “wherein.” Also, in the following claims, the terms “including” and “comprising” are open-ended, that is, an assembly, kit, or method that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented, at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The Abstract is provided to allow the reader to quickly ascertain the nature of the technical disclosure. It is submitted with the understanding that it will not be used to interpret or limit the scope or meaning of the claims.

1. A system, comprising:
a medication module, communicatively coupleable to a portable device, including at least one compartment for storing and dispensing one or more doses of a medication in accordance with a medication program;
a communication module connected to the medication module; and a sensing mechanism, associated with the medication module, configured to detect a medication dispensing activity from the at least one compartment.

2. The system of claim 1, further comprising dosage or compliance information about the medication program, wherein the dosage or compliance information includes one or more of an alert, a positive reinforcement message or action, or a negative reinforcement message or action.

3. The system of claim 1, wherein the sensing mechanism includes a latch configured to control access to the at least one compartment.

4. The system of claim 1, wherein the communicative coupling between the medication module and the portable device includes one or more wires.

5. The system of claim 1, wherein the communicative coupling between the medication module and the portable device includes a wireless connection.

6. The system of claim 1, further comprising a portable device including an electronic communication module, configured to receive and provide to a user and at least one third party dosage or compliance information about the medication program, and a user-interface, configured to display the dosage or compliance information about the medication program to the user and receive data input from the user.

7. The system of claim 6, wherein the user-interface includes a display screen and a plurality of alphanumeric keys.

8. The system of claim 6, wherein the medication module is coupled to a housing of the portable device on a surface opposite the user-interface.

9. The system of claim 6, wherein the medication module forms a perimeter around one or more housing edges of the portable device and is coupled to the portable device at the one or more housing edges.

10. The system of claim 6, wherein the portable device includes a cellular telephone or a smart telephone.

11. The system of claim 1, wherein the medication module includes a drawer in which the at least one compartment is located.

12. The system of claim 1, further comprising:
a radio frequency identification (RFID) tag to be worn by a user;
a mobile device, connected to the medication module;
a transceiver, located in the medication module, configured to receive a signal providing user location information from the RFID tag; and wherein the mobile device is configured to transport the medication module to the user upon receiving instructions concerning the medication program and the location of the user.

13. The system of claim 1, wherein the at least one compartment is configured to receive a cartridge including a dosage of medication.

14. The system of claim 13, wherein the at least one compartment is configured to receive a plurality of cartridges, each cartridge including a dosage of medication.

15. A method of medication dosing, comprising:
receiving, at a portable device, a medication program including a medication dosage and medication timing for a user;
storing at least one dosage of medication in a medication module coupleable to the portable device;
alerting the user about the medication dosage at the medication timing; detecting a medication dispensing activity from the medication module; and informing one or both of the user or a third party about the user's compliance with the medication program.

16. The method of claim 15, wherein informing the user about compliance with the medication program includes sending the user a positive reinforcement message or action.

17. The method of claim 16, wherein sending the user the positive reinforcement message or action includes sending the user a reward in the form of a credit, a point, a discounted item, or money.

18. The method of claim 16, wherein sending the user the positive reinforcement message or action includes sending the user a personalized audio, visual, tactile, or text message from a family member, caregiver, or friend.

19. The method of claim 15, wherein informing the user about compliance with the medication program includes initiating a negative reinforcement message or action.

20. The method of claim 19, wherein initiating the negative reinforcement message or action includes locking the portable device for all uses except emergency call use.

21. The method of claim 19, wherein initiating the negative reinforcement message or action includes at least one of increasing an insurance premium, increasing fees at a medical provider, or increasing fees at a pharmacy.

22. The system of claim 12, wherein the at least one compartment is configured to receive a cartridge including a dosage of medication.
